(19) United States
(12) Patent Application Publication
(10) Pub. No.: US 2007/0057557 A1
(43) Pub. Date: Mar. 15, 2007

(54) Bed seat for transportation facilities

(76) Inventor: Young Hyun Moon, Seoul (KR)

Correspondence Address: PARK LAW FIRM, 3255 WILSHIRE BLVD, SUITE 1110, LOS ANGELES, CA, 90010, US

(21) Appl. No.: 10/555,987

(22) PCT Filed: May 27, 2003
(86) PCT No.: PCT/KR03/01030

§ 371 Date: Nov. 8, 2005

(30) Foreign Application Priority Data
May 19, 2003 (KR) 10-2003-0031595

(51) Int. Cl. B60N 2/34

(52) U.S. Cl. 297/354.13; 297/243

(57) ABSTRACT

The berthable seat of the invention is broadly adapted to various transportation facilities such as a train, a ship, an express line and an airplane as well as a passenger car and an omnibus having a front and rear seat. According to the invention, a back of the front seat is provided with an upper partition of the back of seat and lower fixing part of the back of a seat, the upper partition of the back of the seat is formed to be divided in half into a forward separating plank and backward separating plank to unfold horizontally by developing forwardly or backwardly or to stand up by folding and joining the planks, and a back of the rear seat forms a concavity for laying a head of a passenger. Thus, when the forward and backward separating planks are developed horizontally, a plain bed surface is provided so that a passenger may lie in the seat comfortably.

### TECHNICAL FIELD

This invention relates to a berthable seat of transportation facilities for conveying an old and week person or a patient with lying in the seat or providing a passenger with a comfortable position in the seat to take a rest, and more particularly to a berthable seat of transportation facilities such as a train, a ship, an express bus and an airplane having seats as well as a passenger car and an omnibus having the front and rear seat for conveying safely an old and week person or a patient with lying in the seat like a bed of an ambulance or providing a passenger with a stable and comfortable is position in the seat to take a rest by providing a constitution that a back of the front seat is provided with an upper partition of the back of a seat and a lower fixing part of the back of a seat, the upper partition of the back of the seat is formed to be divided in half into a forward separating plank and a backward separating plank to unfold horizontally by developing forwardly or backwardly or to stand up by folding and joining the planks, and a back of the rear seat forms a concavity for laying a head of a passenger.

### BACKGROUND ART

Generally, the transportation facilities, such as a passenger car or an omnibus, have front seats for a driver and an assistant and rear seat for a passenger. Recently, the driver or the passenger has requested to take a rest due to driving for a long time.

However, when the driver or the passenger wants to take a rest in the seat for a long time in the course of parking or stop, the driver or the passenger cannot take a sufficient rest since the driver or the passenger take a rest with leaning back in the seat. This uncomfortable state causes fatigue and inconvenience to the driver or the passenger. Further, in the case of a driver seat and an assistant seat, the back of the seat is adjusted to be inclined forwardly or backwardly, and is turned over near the horizontal surface. However, even if the back of the seat is turned over backwardly to be in a horizontal state, the back is obstructed by the seat of the rear seat, and a plain surface cannot be formed since a height of the front seat is different from that of the rear seat. Thus, in the case of lying in the seat for a long time, a muscular pain may occur since a specific part of a human body, such as a waist or a hip, is stressed, and thus a comfortable rest cannot be taken.

Further, a front seat and a rear seat of the prior art installed within a car have a structure that a passenger should lean back in the seat to take a rest. Thus, an old and weak person or a patient suffers inconvenience since it is not possible to stretch the legs during a rest. This is not preferable to a conveyance at a long distance for an old and weak person or a patient. Further, in the case of conveying an emergency patient in the night, the conveyance cannot be easily prosecuted due to such a structural weakness, and thus the patient may suffer a fatal influence due to a delay.

Moreover, mass transportation facilities, such as a train, a ship, an express bus, or an airplane, has mainly a structure of a seat for conveying a passenger in bulk. Thus, when an emergency patient occurs during driving, a prompt emergence treatment cannot be mostly prosecuted, and thus an ability dealing with the accident is largely restricted.

### DISCLOSURE OF THE INVENTION

Accordingly, in order to resolve the above problems, an object of the invention is to provide a berthable seat, which is adapted to various transportation facilities such as a train, a ship, an express bus and an airplane as well as a passenger car and an omnibus, provides a constitution that a back of the front seat is provided with an upper partition of the back of a seat and a lower fixing part of the back of a seat, the upper partition of the back of the seat is formed to be divided in half into a forward separating plank and a backward separating plank to unfold horizontally by developing forwardly or backwardly or to stand up by folding and joining the planks, and a back of the rear seat forms a concavity for laying a head of a passenger, and thus provides a passenger with a stable and comfortable position in the seat to take a rest by developing each plank of the upper partition of the back of the front seat forwardly and backwardly.

Further, another object of the invention is to provide a berthable seat for carrying an old and week person or a patient with lying in the seat comfortably by developing each plank of the upper partition of the back of the front seat forwardly and backwardly upon boarding the old and week person or the patient so that even the old and week person or the patient may have a long-distance travel comfortably.

Further, another object of the invention is to provide a berthable seat for conveying promptly an emergency patient occurred home or in the office, or in the course of traveling by laying down the patient in a comfortable position and securing the patient with a seatbelt so that a patient whose life is in danger according to a delay of a standby time for a conveyance may be effectively rescued.

To accomplish these objects, the berthable seat of the invention is broadly adapted to various transportation facilities such as a train, a ship, an express line and an airplane as well as a passenger car and an omnibus having a front and rear seat. Further, the invention provides a constitution that a back of the front seat is provided with an upper partition of the back of a seat and a lower fixing part of the back of a seat, the upper partition of the back of the seat is formed to be divided in half into a forward separating plank and a backward separating plank to unfold horizontally by developing forwardly or backwardly or to stand up by folding and joining the planks, and a back of the rear seat forms a concavity for laying a head of a passenger.

The above and other objects of the invention will be seen by reference to the description taken in connection with the accompanying drawings.

### BRIEF DESCRIPTION OF THE DRAWINGS

FIG. 1 is a perspective view showing the status developing a part of the back of a seat of the invention.

FIG. 2 is a rear perspective view of a front seat according to the invention.

FIGS. 3 to 6 are section views showing the operational status of the invention, FIG. 3 being a section view showing the engaging status, FIG. 4 being a section view showing the initiative operation for the development of the seat, FIG. 5 being a section view of the finished status of the development showing the status that a passenger lies in a seat, and FIG. 6 being a section view showing the status that a passenger leans back in a seat.

FIG. 7 is a section view taken on line A-A in FIG. 2, showing the joining status of the invention.

FIG. 8 is a view showing another embodiment of a concavity for laying a head according to the invention.

### BEST MODE FOR CARRYING OUT THE INVENTION

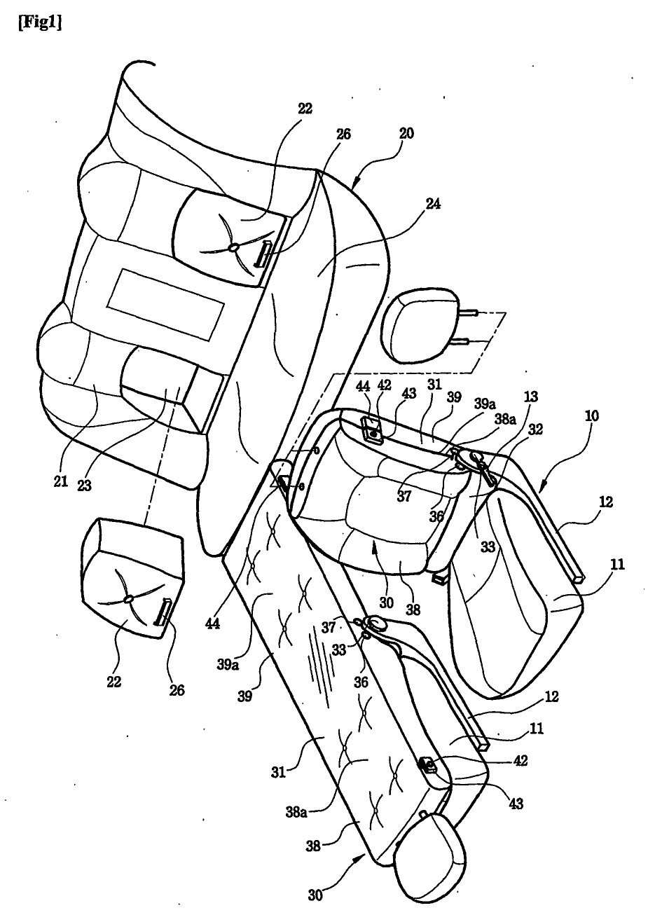

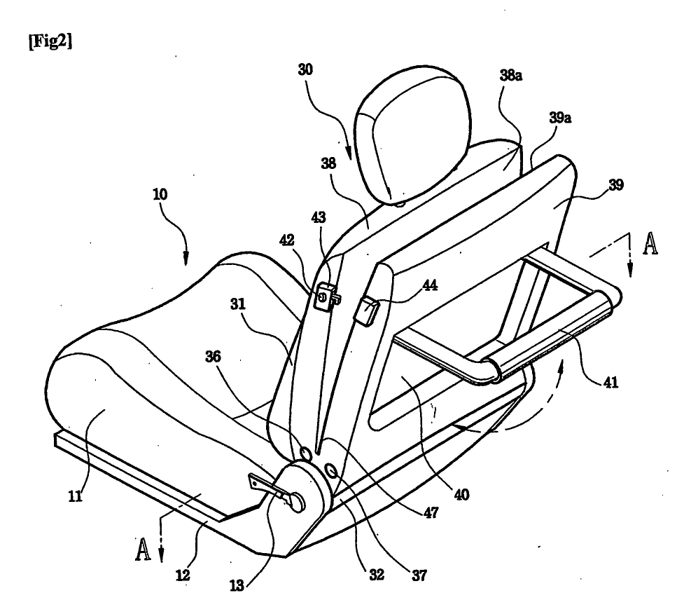

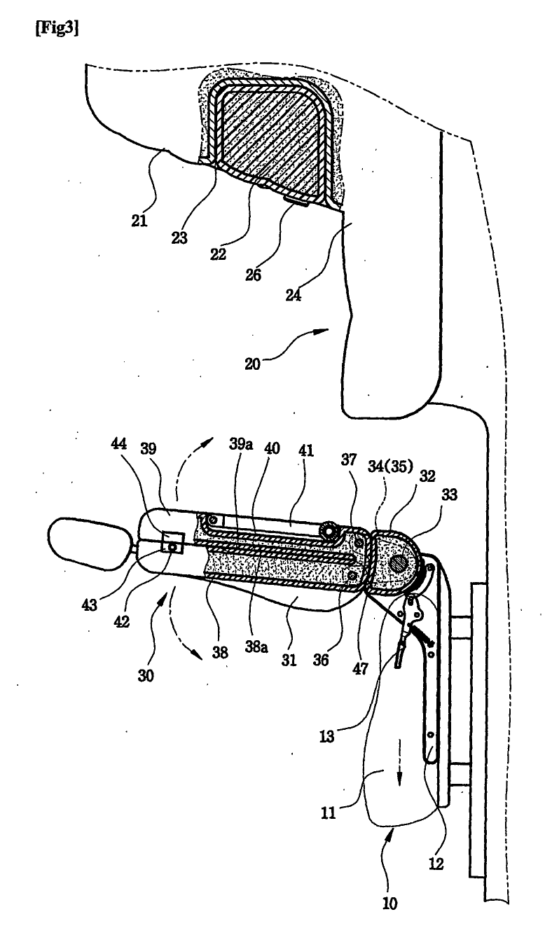

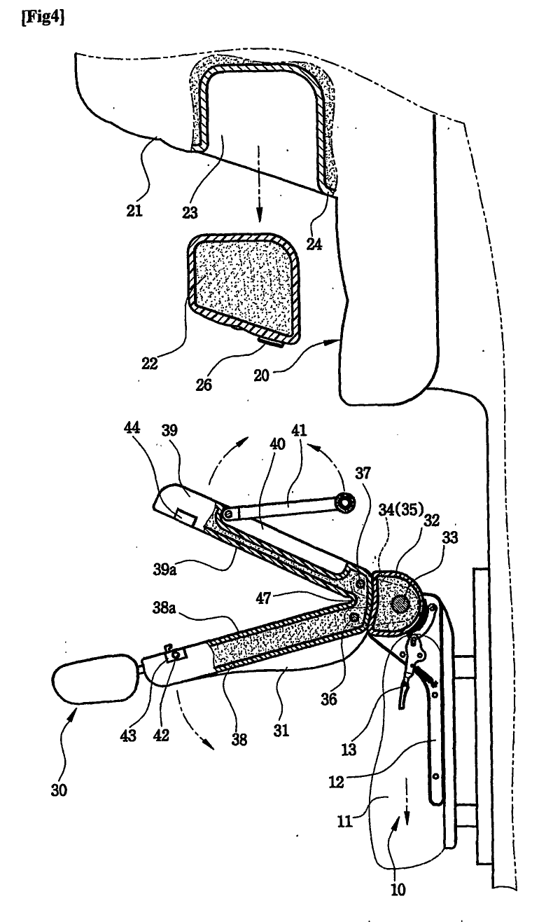

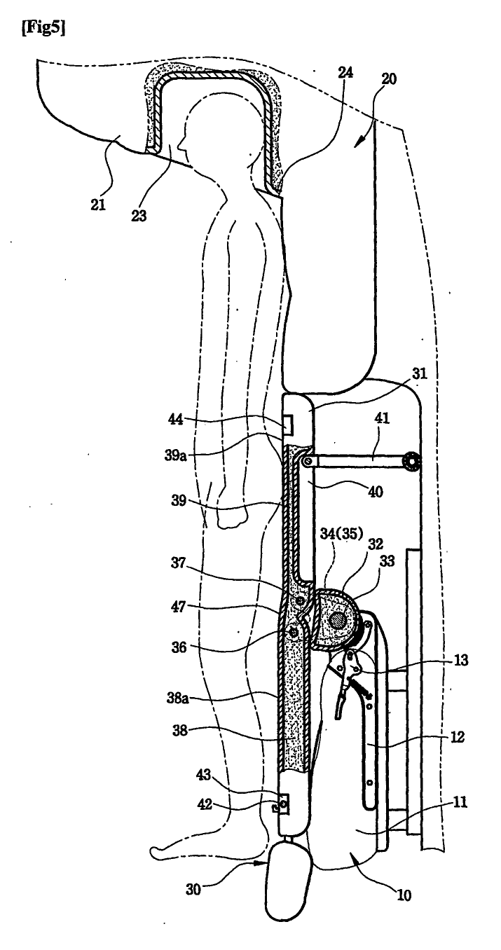

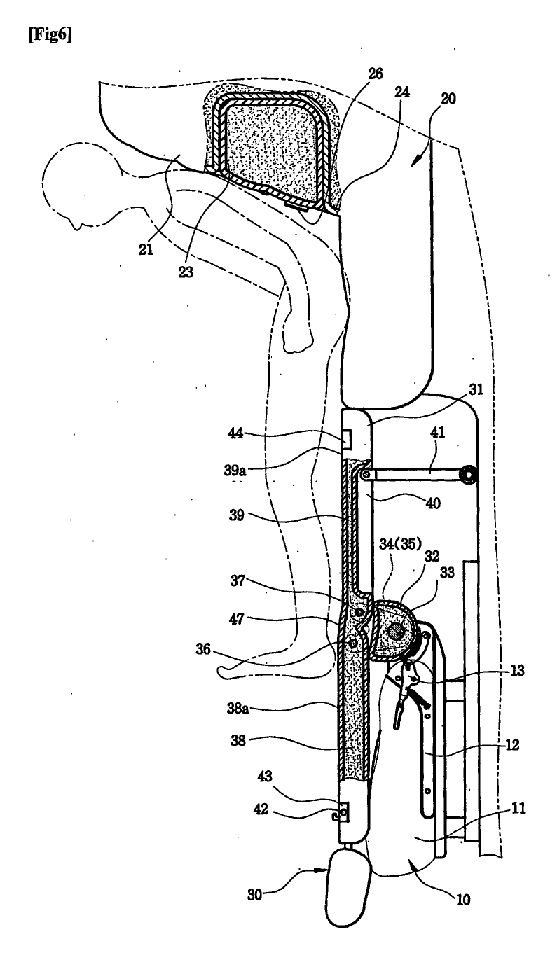

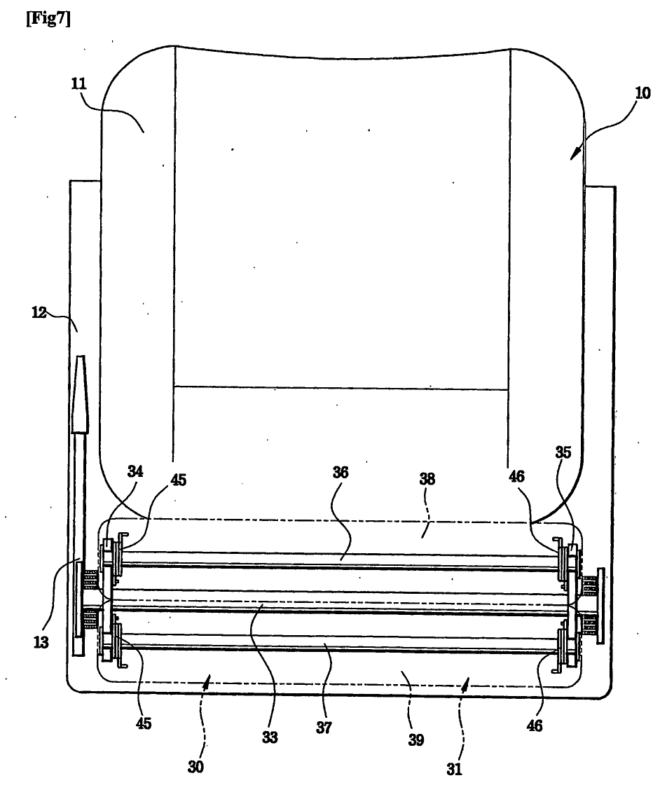

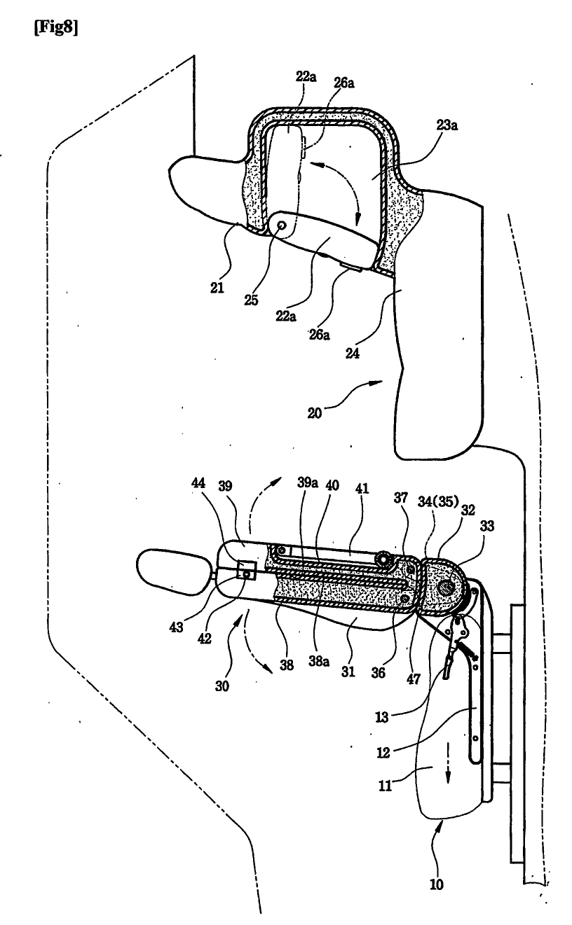

FIG. 1 is a perspective view showing the status developing a part of the back of a seat of the invention, FIG. 2 is a rear perspective view of a front seat according to the invention, FIGS. 3 to 6 are section views showing the operational status of the invention, FIG. 3 being a section view showing the engaging status, FIG. 4 being a section view showing the initiative operation for the development of the seat, FIG. 5 being a section view of the finished status of the development showing the status that a passenger lies in a seat, and FIG. 6 being a section view showing the status that a passenger leans back in a seat, FIG. 7 is a section view taken on line A-A in FIG. 2, showing the joining status of the invention, and FIG. 8 is a view showing an another embodiment of a concavity for laying a head according to the invention.

With reference to FIGS. 1 to 8, the invention will be explained by embodiments of a passenger car or an omnibus including a front seat 10 and a rear seat 20.

The invention relates to a passenger car or a omnibus having a front seat 10 and a rear seat 20. The invention comprises a back 30 of the front seat 10 partitioning an upper partition 31 of the back of a seat and a lower fixing part 32 of the back of a seat. The lower fixing part 32 of the back of the seat is mounted to a tilting shaft 33 tilting the prior back 30 forwardly or backwardly. “V” type brackets 34, 35 having supporting shafts 36, 37 are linked with the either side of the tilting shaft 33. The upper partition 31 of the back of the seat is mounted to the supporting shafts 36, 37. The upper partition 31 of the back of the seat is formed to be divided in half into a forward separating plank 38 and a backward separating plank 39 to unfold horizontally by developing forwardly or backwardly or to stand up by folding and joining the planks 38, 39. Leg 41, which is able to stand up, is mounted in a concave part 40 formed in rear surface of the backward separating plank 39 of the upper partition 31 of the back of the seat. A back 21 of the rear seat 20 forms a concavity 23 for laying a head enclosing detachably a cushion 22 for supporting a head.

Further, joining buckles 43, 44 having a separating button 42 are mounted to the upper part of the forward and backward separating planks 38, 39 of the upper partition 31 of the back of the seat. Springs 45, 46 developing the forward and backward separating planks 38, 39 are mounted to either side of the supporting shafts 36, 37. When the joining buckles 45, 46 are uncoupled, the forward and backward separating planks 38, 39 are developed and unfolded promptly and easily forwardly or backwardly by spring force of the springs 45, 46. When the joining buckles 45, 46 are coupled, the buckles 45, 46 are not separated even if an external collision due to a traffic accident, such as a rear-end collision accident, occurs. Thus, the forward and backward separating planks 38, 39 also are not separated due to such a accident.

The joining buckles 43, 44 have a button type structure having the separating button 42 or a lever type structure having lever or crossbar.

Further, a lower fold connecting part 47 integrates the forward and backward separating planks 38, 39. Thus, when the forward and backward separating planks 38, 39 are developed, internal surfaces 38a, 39a of the forward and backward separating planks 38, 39 are even with fold connecting part 47 so that a passenger may lie down in a comfortable position.

Further, the back 21 of the rear seat 20 is provided with the concavity 23 for laying a head so that a head of a passenger may place in the concavity 23 with supported by a pillow. When the forward and backward separating planks 38, 39 are developed and the leg 41 received within the concave part 40 of the backward separating plank 39 is drawn out and stood up for supporting, the internal surfaces 38a, 39a of the forward and backward separating planks 38, 39, the fold connecting part 47, seat 24 of the rear seat 20, and the concavity 23 for laying the head are placed horizontally. Thus, even a passenger of great stature may lie in a comfortable and stable position and take a rest if the head is laid within the concavity 23 with supported by a pillow.

Further, the back 30 of the front seat 10 has two partitions consisting of the upper partition 31 of the back of a seat and the lower fixing part 32 of the back of a seat. The lower fixing part 32 of the back of a seat is mixed to the “V” type brackets 34, 35 fixed securely to the either side of the titling shaft 33 of the control means 13 for tilting the back of the seat mounted to steel frame 12 supporting a seat 11 of the front seat 10. The upper partition 31 of the back of a seat is supported by the supporting shaft 36, 37 mounted to the “V” type brackets 34, 35. Thus, the upper partition 31 has a rotatable structure like a common back of the seat for a passenger car, and provides security and safety.

Further, according to the invention, as shown in FIG. 5, when the upper partition of the back of the seat 30 is unfolded and developed evenly like a bed, and then the cushion 22 for supporting the head is removed from the concavity 23 for laying the head, a passenger may lay down in a comfortable position by placing the head within the concavity 23. Thus, when conveying a old and weak person or a patient, the person may be conveyed in a comfortable position and take a rest. Further, referring to FIG. 6, when the cushion 22 is received within the concavity 23 of the back 21 of the rear seat 20, a passenger may take a rest with leaning back in the back 21 of the rear seat 20 and stretching the limbs.

Further, according to the invention, upon forming the concavity 23 for laying the head and the cushion 22 for supporting the head within the back 21 of the rear seat 20, as shown in FIG. 6, the cushion 22 may be received detachably within the concavity 23. Further, referring to FIG. 7, the concavity 23a for laying the head may be formed more deeply backward of the back 21, instead of the cushion 22 removed from the back 21 of the rear seat 20, a back supporting member 22 a may be rotatably mounted by a pin 25 within the concavity 23a, and then open and close the concavity 23a. Further, hand straps 26, 26a may be attached to each front surface of the cushion 22 and the back supporting member 22a to draw out and insert easily the cushion 22 and the back supporting member 22a.

Although the preferred embodiments of the invention have been disclosed only for a passenger car or an omnibus having a front seat and a rear seat, it is of course that the scope of the invention is not limited to such a transportation facilities, but adapted to the various transportation facilities such as an airplane as well as a train, a ship, and an express bus having a front and a rear seat, and thus the invention provides a passenger, emergency patient, and an old and weak person with a comfortable and stable position in a state of emergency as well as normal times by changing the front and rear seat into a bed.

### INDUSTRIAL APPLICABILITY

From the foregoing, the berthable seat of the invention is broadly adapted to various transportation facilities such as a train, a ship, an express line and an airplane as well as a passenger car and an omnibus having a front and rear seat. According to the invention, a back of the front seat is provided with an upper partition of the back of a seat and a lower fixing part of the back of a seat, the upper partition of the back of the seat is formed to be divided in half into a forward separating plank and a backward separating plank to unfold horizontally by developing forwardly or backwardly or to stand up by folding and joining the planks, and a back of the rear seat forms a concavity for laying a head of a passenger. Thus, when the forward and backward separating planks are developed horizontally, a plain bed surface is provided so that a passenger may lie in the seat comfortably. Further, since a head of a passenger is laid within the concavity with supported by a pillow, even a passenger of great stature may lie in a comfortable and stable position and take a rest. Accordingly, the berthable seat of the invention may convey safely an old and week person or a patient with lying in the seat like a bed of an ambulance or provides a passenger with a stable and comfortable position in the seat to take a rest.

What is claims is:

1. A berthable seat for transportation facilities having a front seat 10 and a rear seat 20, comprising:
a back 30 of the front seat 10 partitioning an upper partition 31 of the back of a seat and a lower fixing part 32 of the back of a seat, the upper partition 31 of the back of the seat being formed to be divided in half into a forward separating plank 38 and a backward separating plank 39 to unfold horizontally by developing forwardly or backwardly or to stand up by folding and joining the planks 38, 39;
a leg 41, which is able to stand up, mounted in a concave part 40 of the backward separating plank 39 of the upper partition 31 of the back of the seat; and
a back 21 of the rear seat 20 forming a concavity 23 for laying a head enclosing detachably a cushion 22 for supporting a head.

2. The seat according to claim 1, wherein the lower fixing part 32 of the back of the seat is fixed to a control means 13 for tilting the back of the seat and is linked with the control means 13.

3. The seat according to claim 1, wherein the upper partition 31 of the back of the seat divides into halves forwardly or backwardly and develops to form the forward separating plank 38 and the backward separating plank 39.
